(19) United States
(12) Patent Application Publication
(10) Pub. No.: US 2015/0278943 A1
(43) Pub. Date: Oct. 1, 2015

(54) SYSTEM AND METHOD FOR FINANCIING COMMUNITY SHARED VEHICLES BASED ON AMENITY VALUE OF SHARED VEHICLE PROGRAMS

(71) Applicant: Nissan North America, Inc., Franklin, TN (US)

(72) Inventors: Vikram Krishnamurthy, Smyrna, GA (US); David Peterson, West Hollywood, CA (US); Toshiro Muramatsu, Sunnyvale, CA (US)

(73) Assignee: Nissan North America, Inc., Franklin, TN (US)

(21) Appl. No.: 14/231,786

(22) Filed: Apr. 1, 2014

(51) Int. Cl. G06Q 40/02; G06Q 30/02

(52) U.S. Cl. CPC G06Q 40/025; G06Q 30/0278

(57) ABSTRACT

Methods and systems provide a derivative financing product for a community shared vehicle program by establishing a line of credit for each participating home to pay for the community shared vehicle program. The line of credit derives value from both tangible and intangible values of the community shared vehicle program. The line of credit is established by estimating a total home value per participating home at a start of a financing term based on an estimated amenity value of the community shared vehicle program for the financing term and a number of participating homes, estimating a cost of the community shared vehicle program for the financing term per participating home and determining a periodic payment per participating home based on periodic payment throughout the financing term to be paid from the line of credit to cover the total cost of the community shared vehicle program while providing a profit.

### TECHNICAL FIELD

This disclosure relates to systems and methods for financing community shared vehicles, an in particular, financing through increased home values due at least in part to the amenity value of the community shared vehicle program.

### BACKGROUND

In certain communities, the use of shared vehicles, especially electric vehicles, is an amenity that can provide those with constrained, limited, or no personal transportation, a mobility service. However, there are high costs associated with providing a shared vehicle system, including the high cost of the vehicles themselves, the cost for the infrastructure for storing and charging the vehicles, and the installation of and operation of the billing and payment systems. Conventional shared vehicle systems require a user to pay per the use of a vehicle or pay a monthly fee to use the service independent of the amount of use. The shared vehicle system user must use disposable income to pay for the service, which can be a deterrent for many users. Due to the high costs associated with providing the shared vehicle systems, entities that might otherwise offer such a system do not do so as funds are not available or are difficult to raise.

### SUMMARY

Disclosed herein are methods and systems for providing a derivative financing product for a community shared vehicle program. One method for providing a derivative financing product for a community shared vehicle program comprises establishing a line of credit for each participating home to pay for the community shared vehicle program, wherein the line of credit derives value from both tangible and intangible values of the community shared vehicle program. The line of credit is established by estimating, with a computer, a total home value per participating home at a start of a financing term based on an estimated amenity value of the community shared vehicle program for the financing term and a number of participating homes, estimating a total cost of the community shared vehicle program for the financing term, determining a cost per participating home based on the total cost and the number of participating homes and determining a periodic payment per participating home based on periodic payment throughout the financing term to be paid from the line of credit to cover the total cost of the community shared vehicle program while providing a profit.

The total cost of the community shared vehicle program includes a cost of shared vehicles, a cost of a charging system, installation costs of the charging system, insurance for the shared vehicles, maintenance costs, utility costs, and program operation cost. The total cost of the community shared vehicle program further includes cost of financial product fees, which includes one or more of interest rate cost, default swap fee, home appraisal fee, and derivative product fee.

The financing term includes a plurality of data collection periods, and the method can further comprise updating the total home value per participating home at an end of each data collection period using data collected during a respective data collection period, updating the total cost of the community shared vehicle program for the respective data collection period using data collected during the respective data collection period, determining an updated cost per participating home based on the updated total cost and the number of participating homes and determining an updated periodic payment per participating home to be paid through a subsequent data collection period from the line of credit to cover the updated total cost of the community shared vehicle program while providing an updated profit payment.

Updating the total home value comprises determining an updated amenity value of the community shared vehicle program for each participating home in a serviced community at the end of the data collection period, determining a home appraisal at the end of the data collection period for each participating homeowner and combining the home appraisal with the updated amenity value to determine an updated total home value for each participating homeowner at the end of the data collection period. Determining the updated period payment comprises determining a percent increase in home value by comparing the updated total home value to a total home value at a start of the data collection period, determining a difference between the percent increase and a preselected house pricing index, wherein a gain over the preselected house pricing index provides the stream of income and adjusting the periodic payment based on the difference. The updated periodic payment is increased if the difference is positive, the increase providing the updated profit payment.

Data can be collected from an on-board vehicle controller of each shared vehicle, the data including one or more of miles driven per day, miles driven per leg of trip, number of destinations per day, destinations, time per day of vehicle operation, and number of different vehicle users per day. Data can also be received by a participant through a user interface. Data can also be collected from databases including one or more of regional fuel costs and regional electrical power costs. Collecting data can also comprise monitoring social media for one or more of a number of references of and a type of reference to the community shared vehicle program.

Also disclosed are systems for providing a derivative financing product for a community shared vehicle program. One such system comprises a computer system configured to carry out the operations of establishing a line of credit for each participating home to pay for the community shared vehicle program, wherein the line of credit derives value from both tangible and intangible values of the community shared vehicle program. The line of credit can be established by estimating a total home value per participating home at a start of a financing term based on an estimated amenity value of the community shared vehicle program for the financing term and a number of participating homes, estimating a total cost of the community shared vehicle program for the financing term, determining a cost per participating home based on the total cost and the number of participating homes and determining a periodic payment per participating home based on periodic payment throughout the financing term to be paid from the line of credit to cover the total cost of the community shared vehicle program while providing a profit.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a flow diagram of a method of establishing a financial product enabling the provision of a community shared vehicle program to a community of households;

FIG. 2 is a schematic illustrating the determination of an updated amenity value of the community shared vehicle program;

FIG. 3 is a flow diagram of the determination of the updated amenity value of the community shared vehicle program; and

FIG. 4 is a schematic of the financial product system illustrating an embodiment of the modules or units of the system and its incoming revenue and outgoing expenses.

### DETAILED DESCRIPTION

Community shared vehicles can be used in a wide variety of communities. As non-limiting examples, community shared vehicles can be used in a traditional housing development typically found in suburban areas, apartment/condominium complexes with or without a parking structure, or an agglomeration of homes in a “near” city environment.

Each of these communities can be occupied by diverse types of people ranging from singles to partners with no children, to partners or married couples with children. The available pool of potential homeowners for a community with community shared vehicles will be higher than compared to communities without community shared vehicles. This larger available pool of homeowners increases demand for the homes in the community with a shared vehicle system, leading to increased home values. Homeowners who use the community shared vehicle system will realize a cost savings as their mobility needs are met without the need to purchase, lease or rent a vehicle on their own with no shared costs.

In new and existing construction of multi-unit dwellings (e.g., apartments, townhouses, and condominiums) the cost of installing charging stations to charge electric vehicles can be significantly more expensive than the cost of installing a charging station in an attached/detaches garage belonging to a single family home. The cost of purchasing, leasing or renting multiple vehicles to supply the community shared system is also high. Additional cost to store the vehicles in a central location during non-use that is easily accessible to the community of users is an additional expense that is necessary to establish such a system. These high costs are currently deterrents to establishing community shared vehicle systems. The methods and systems herein address these high costs of implementation and provide means to finance such systems without presenting the user of the shared vehicle systems with excessive costs.

The candidate community for the shared vehicle program will be one in which the increase in the average home value in the community combined with the average cost savings per homeowner for transportation over a predetermined time period is greater than the total cost per homeowner for the community shared vehicles. Examples of such communities include urban and suburban residential communities, apartment complexes, condominium complexes, and others.

To establish a community shared vehicle system, a community shared vehicle program provider (CSV program provider) can lease or purchase a number of electric vehicles (EVs) and an EV charging system to exchange power with the EVs. Installation of the charging system is another necessary and costly expense. The CSV program provider will be responsible for at least the following costs: costs for the EV vehicles (leasing cost, purchase cost and/or financing costs); purchase, lease and/or financing costs for the EV charging system; cost of installation of the charging system; utility costs and/or fuel costs to power the EVs and the charging station; insurance costs; vehicle maintenance and system maintenance costs; and program operational costs associated with, for example, a vehicle reservation system. All of these costs contribute to the total cost for a community shared vehicle program. It is clear from all of these costs that a simple pay-as-you-go system or a monthly fee paid by participating homeowners would offer a rate of return on investment to the CSV program provider that is so low as to make the provision of such a service undesirable. Furthermore, passing through these costs directly to the users of the program through a periodic payment, such as a monthly payment, may deter homeowners from participating in the program. As fewer homeowners participate, the higher the cost to be borne by those who do participate.

Disclosed herein is a financial product for community shared vehicle programs that provides a means for a CSV program provider to obtain financing to provide the CSV program to a community. The financing product also provides a means for users to pay for the program through equity gained by the amenity value of having the program in the users' community. Also disclosed herein are systems and methods for determining the amenity value of the community shared vehicle program. The financing system can also include a securitization process for securitizing the financial product. Providing community shared vehicle systems with the financing systems herein benefits the environment, provides transportation to those with not enough or none, increases an individual's financial worth, and provides a platform for increasing and improving relationships within the community. The financial product herein is a derivative instrument, deriving its value from the value and characteristics of the community shared vehicle program.

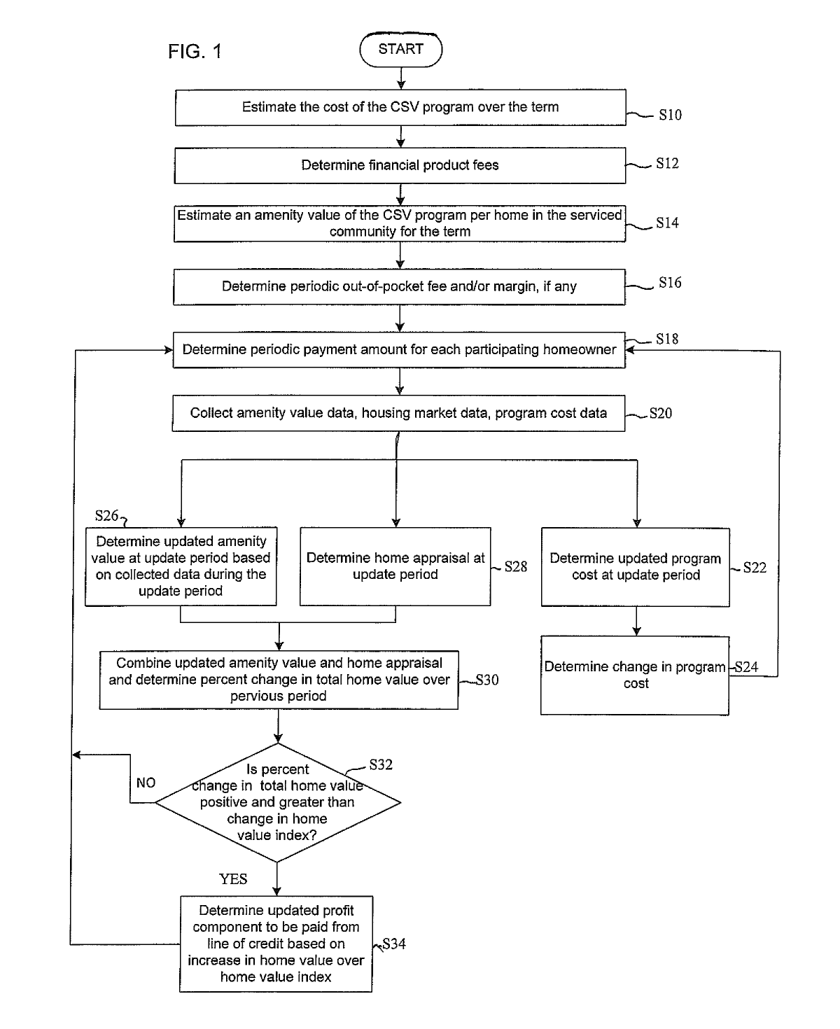

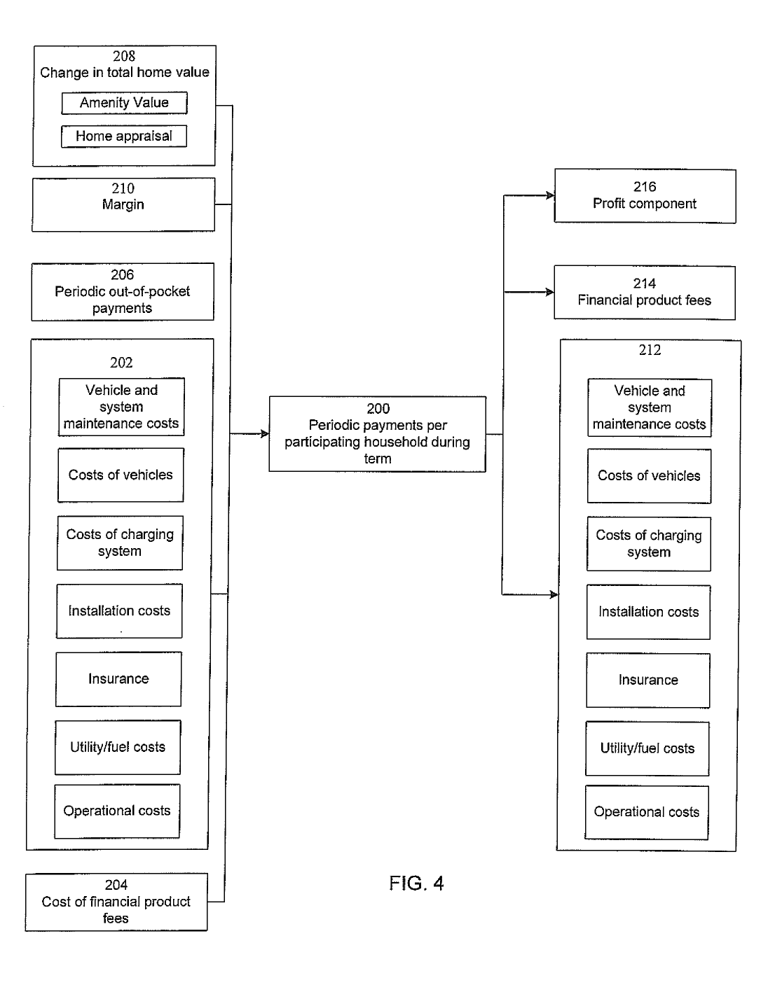

FIG. 1 is a flow diagram of a method of establishing a financial product for a community shared vehicle program for a particular term. FIG. 4 is a schematic of a system for creating and updating the financial product, along with the income and expenses on which the financial product is based. The financial product is established for a term such as three, four or five years, similar to terms of lease programs or other financing programs. The financial product relies on the participation of at least three parties: the participating homeowner; the CSV program provider; and a financing party such as a bank. An example of a CSV program provider is any entity capable of providing at a minimum the EVs, EV charging stations and the installation, as well as the other operational, maintenance and insurance requirements, perhaps through the use of third parties. An example of such and entity is an OEM, a home owners association, an investor or a builder that builds the homes in the community serviced by the program. The financing party or bank is not limiting and can refer to any type of bank or investment group. For example, an automotive OEM might obtain financing through its financing arm.

In step S10, the cost over the term to the CSV program provider will be estimated based on the costs described above incurred in providing the CSV program. The costs include, but are not limited to, the cost for the EV vehicle (leasing, purchasing and/or financing costs), cost for the EV charging system (leasing, purchase and/or financing costs), installation costs, utility costs and/or fuel costs to power the EVs, insurance costs, vehicle and system maintenance costs and program operational costs. A majority of these costs will be established with certainty at when the program is established. For example, financing for the cost of each EV vehicle, the cost of the charging system, and installation costs will be obtained prior to the program launching. Other costs will be estimated based on data available at the time. For example, insurance, utility and fuel costs, and operational costs can be estimated based on current rates and current trends.

In step S12, financial product fees incurred for providing the financial product are determined. The financial fees include one or more of the following: interest rate for the line of credit, a fee for the derivative product, a home appraisal fee and a credit default swap fee. The credit default swap is not a necessary component, but is included by means of example. The credit default swap fee will be subscribed by the financing party and issued by the bank to mitigate the risk of a default by the homeowner. This fee will be paid by the financing party to the bank or other issuer of the swap.

The cost of the program determined in step S10 along with the default swap fee in step S12 are combined and divided over the term to arrive at a periodic payment that must be made by the participating homeowners to cover the estimated costs incurred. To provide a means to profit from providing the CSV program to the community, the increase in home value to each participating homeowner is determined. This increase in value represents a pool from which a profit can be paid by the participating homeowners to the CSV program provider and/or financial party. When the financial product is first established, this pool is determined from an estimated amenity value of the CSV program at the end of the term.

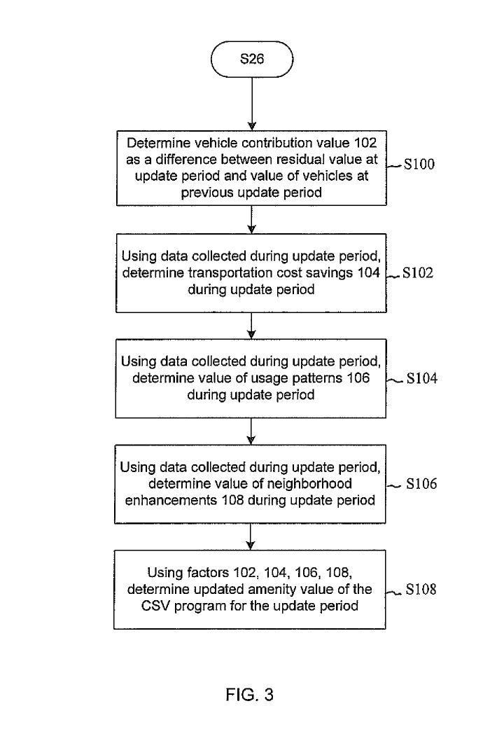

The amenity value of the community shared vehicle program for the full term of the financial product is estimated on a per home basis for participating homes in the community being served by the program in step S14. Estimating the amenity value of the program over the course of the term is performed using a plurality of factors. The factors can include the number of vehicles to be offered through the program, the difference between the original vehicle value and final estimated residual value of those vehicles, the number of estimated participating home owners in the serviced community, and estimated usage amount of the vehicles in miles traveled, an estimated savings realized by the users of the program, including estimated fuel savings and opportunity cost savings, and an estimated value of the enhancement to the community characteristics resulting from the community shared vehicle program. These are discussed in more detail below with reference to FIG. 3 where these factors are actually calculated. In step S14, however, in establishing the amenity value of the community shared vehicle program, these factors are estimated to arrive at an amenity value per home over the term of the financial product. If such programs have been established in other areas, data from other programs can be used to assist in the estimation, increasing the accuracy of the estimation.

The profit to be collected by the CSV program provider and/or the financing party is a percentage of the estimated amenity value over the course of the term. For example, if the amenity value is estimated to be X, profit payments may be determined by taking 20% of X and dividing by the number of payments to be made over the term.

Because the financial product is initially established using estimated costs and an estimated profit pool, the program can include more than one way to provide a margin of error in the estimations to ensure the program costs are paid. A small out-of-pocket fee can be paid by each participating homeowner on a periodic basis. In step S16, any periodic payment that will be charged to a participating homeowner is accounted for as income for the financial product. As discussed, any out-of-pocket fees for the participating homeowners are desirably held to a minimum or even eliminated. However, a nominal fee paid periodically by the participating homeowners, such as $10 to $50 per month, can provide a supplemental income to the financial product on top of the amenity value. The out-of-pocket fees can be paid to the financial product as illustrated in FIG. 4 and combined with the other income to pay the costs. The out-of-pocket fees can be paid to the financial product and passed through to designated third parties, such as the operational provider or the utility or fuel provider. It is also contemplated that the out-of-pocket fees be paid directly to the third party provider or directly to the CSV program provider, such as an HOA, which in turn pays the designated third parties directly with the out-of-pocket fees collected. If the out-of-pocket fees are paid directly to the third parties, the costs of the program in step S12 will be adjusted accordingly to remove the costs being directly paid from the financial product. The examples used herein will figure all costs in establishing the financial product, and include any out-of-pocket fees as income to the financial product.

Another way to provide a margin of error in the estimations to ensure the program costs are paid is to include an actual margin, or percentage increase, in the periodic payments to account for discrepancies or inaccuracies in the estimation process of both the costs and the amenity value, as well as fluctuations in the number of participating homeowners. The margin protects the banks and the CSV program provider from potential underestimating of costs and/or overestimating of the amenity value. Yet another way to provide margin of error is to adjust the percentage of the estimated amenity value taken as profit.

In step S18, the financial product is established for the community serviced by the CSV program. Each participating homeowner will have access to the financial product through a line of credit. This line of credit will be established specifically to pay for the use of the CSV program by the homeowner. The fee to be paid by each participating homeowner on a periodic basis through the line of credit is determined from the periodic payments for the costs, financial product fees, out-of-pocket fees, if any, margin, if any, and profit payment determined as a percentage of the estimated amenity value.

With the financial product in place, the CSV program can be established and participating homeowners can begin to use the program. Periodic payments will be made through each participating homeowner's line of credit to pay for the financing, maintenance and operational costs of the CSV program. The periodic payments can be based on a fixed APR or can be a fixed dollar amount. The payments can be made automatically from the line of credit, or the participating homeowners can be provided with a smart credit card specifically for the community shared vehicle system, herein referred to as a “CSV smart card”. The CSV smart card is similar to a credit card but draws money from the line of credit and is used exclusively for the CSV program. No fees will be charged to the participating homeowner to use the CSV smart card, as any service fees will be built into the financial product.

Data is collected for all aspects of the CSV program in step S20. Data collection begins as soon as the EVs in the program are put in use and continues throughout the use of the program. The data can be collected continuously or on a batch basis. Data can be collected through a variety of means, including electronic means, wireless means and manual means. The data can be collected by any type of data logging device, such as, but not limited to, a telematics control unit (TCU), tethered cell phone, secure digital memory cards, on-board diagnostic systems, remote diagnostic systems, or any combination thereof. GPS systems can be used to provide data, as well as databases of regional data such as fuel costs in an area or utility costs in an area can also be used. Data can also be collected directly from a user of the community shared vehicle program or a service provider as part of the program. Other data can be collected from sources that provide the required data either continuously or batch throughout the term, or can be collected when required for use. These are provided as examples and are not meant to be limiting. The system can also include a calculating unit to determine from the data the contributing value of each of the factors that figure into the amenity value of the community shared vehicle program.

Some of the data collected is used to determine an updated program cost at the update period in step S22. An update period is a predetermined period of time, such as six months or one year. At the first update period, the data collected during the update period is used to recalculate the cost of the program. As discussed above, some of the criteria used to determine the estimated program cost will not have changed. For example, unless based on a variable interest rate, financing for the cost of each EV vehicle, the cost of the charging system, and installation costs will likely not have changed. Therefore, the cost for these factors can be determined for the update period. Data collected for the other costs will be used to actually determine those costs for the update period. For example, actual cost of insurance, actual operational costs, etc. will be collected and an actual cost of the program determined for the update period.

In step S24 the change in the program costs from the previously determined program costs will be determined. The method is reiterative and is completed at every update period throughout the term. In step S18, the periodic payments can be adjusted based on the change in the program costs. However, there may not be a need to change the periodic payments if any margin or out-of-pocket fees previously determined in step S16 are sufficient to cover the change.

The data collected is also used to update the amenity value of the CSV program in step S26, as well as used to determine a home appraisal in step S28, and described in more detail below. The financial product relies at least in part on an increase in total home value for participating homeowners over the term of the financial product. This increase in total home value is a combination of the increase in amenity value from the CSV program and the increase in the price of the home. As described with reference to FIG. 1, to establish the financial product for the community shared vehicle program, the amenity value over the term of the program must be estimated. However, as the program operates over time, data is gathered in step S20 from the program that is used to more accurately determine the amenity value of the community shared vehicle program at each update period throughout the term of the financial product. A home appraisal is also to be performed when the amenity value is evaluated at the update period. The amenity value and home appraisal are updated periodically throughout the term at the update periods when the program costs are updated. An update period may occur every six months or one year throughout the term, as non-limiting examples. Fees for obtaining the home appraisal at each update period are included in the financial product fees. Determining an updated amenity value and an updated home appraisal is done at every update period throughout the term of the financial product to better ascertain an actual value of the financial product and to be able to provide more realistic profits to the financing party and/or the CSV program provider, further incentivizing such entities to invest in and offer such programs, thereby enhancing the value of homes in more communities.

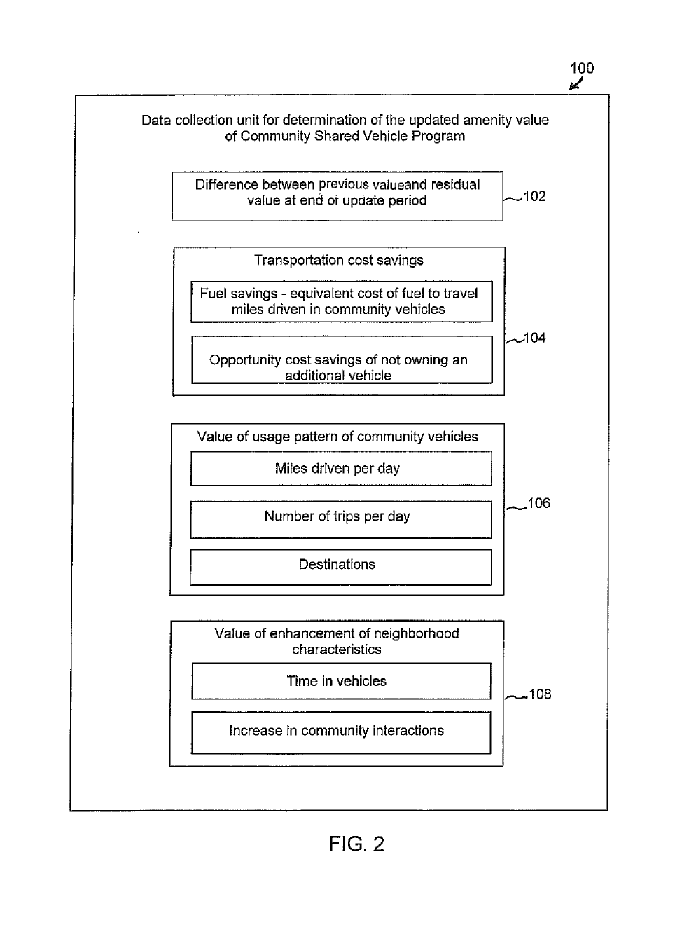

FIG. 2 illustrates a data collection unit 100 configured to collect the factors used to determine the updated amenity value of the CSV program in the serviced community. The factors include, but do not need to be limited to or include all of: vehicle contribution value 102 as the difference between a previous residual value and residual value of the shared vehicles at the end of the update period; transportation cost savings 102 during the update period; usage patterns of the community vehicles 104 during the update period; and impact on neighborhood characteristics 106 during the update period such as time savings, increase in community interaction. As illustration, the National Association of Home Builders (NAHB) has developed spreadsheet-based models to calculate the impact of amenities on home values. The community shared vehicle program can be an amenity that is included in the NAHB spreadsheet to determine the impact of the community shared vehicle program on home values.

As part of determining the updated amenity value, a vehicle contribution value 102 is determined from the difference in the original value of each EV (or previous residual value at the start of the update period) and the residual value of each EV at the end of the update period. Residual value of the vehicles can be determined using the systems and methods provided in U.S. patent application Ser. No. 14/165,878 entitled “Method and Device for Determining Periodic Payment Reduction Based on Extrapolated Residual Value” and filed on Jan. 28, 2014. By means of example, when the amenity value is first estimated, the vehicle contribution value 102 is the difference between the EV original value and its estimated residual value at the end of the term. This difference is the amount of value of the EVs that is “contributed” by the CSV program. At each update period, this vehicle contribution value 102 is the difference between the previous residual value and the residual value at the update period and is the amount of value that has been “provided” by the CSV program during the respective update period.

Another factor in determining the updated amenity value is the transportation cost savings 104 realized by the participating homeowners during the update period. The transportation saving 104 has at least two components: (1) fuel savings realized from not paying to fuel an owned vehicle and (2) opportunity costs saved by not owning or leasing an additional personal use vehicle.

The fuel savings will be calculated based on the data collected for the updated period and can be computed by multiplying the number of miles driven using the EVs in the community shared vehicle program by an actual fuel cost per mile. Fuel cost per mile can be collected during the update period, or an average fuel cost per mile can be calculated for the updated period. From this amount is subtracted the cost of the power required to charge the EVs in the community shared vehicle program. The result is the incremental fuel savings realized by the participating homeowners using the shared vehicles during the update period.

The opportunity cost savings is based on the sum of lease or purchase payments and insurance costs for a “typical” economy vehicle that might be used by a household in the community. This data is gathered for the update period of operation, and is weighted by the ratio of participating homeowners in the neighborhood who would not have needed an additional vehicle even if there were no community cars, to a total number of participating homeowners. The weighting factor accounts for the fact that not all of the participating homeowners will require an additional or any vehicle to use instead of the community vehicle. The opportunity cost can be “averaged” over the entire community as some homeowners may not have any savings whereas others will realize savings.

Another factor in determining the updated amenity value is the value of the usage patterns 106 to the community. The usage patterns 106 of the community shared vehicles are determined from three components: (1) average miles driven per day; (2) average number of trips taken per day; and (3) destination of trips (e.g. grocery store, school, shopping, etc.). The miles driven per day, number of trips and destination of trips are indicative of the level of use of the program by participating homeowners and the impact that the program has on the participating homeowner's lives and the community. Each of these factors is monitored over the life of a community shared vehicle program, with the data for each update period processed at the end of each update period. Each of these factors can be assigned a weighting factor depending on how the factor compares to an average, or benchmark, comparator, rather than using an actual number. For the average miles driven per day, a weighting factor can be given, with the greater number of miles, the greater the value. For the average number of trips per day, the benchmark to which the result is compared for weighing can be obtained from NAHB, for example. The greater the number of trips, the greater the amenity value. For the destination of the trips, a weighting factor can be assigned for a set of typical destinations taken on an average day. The weighting factor for each destination can be assigned based on its impact/benefit to a typical homeowner/community. For example, taking children to or picking children up from school can be assigned a high value, such as a high numeric value from a defined range (i.e. 1 to 10 or 1 to 5, etc.). These factors can be combined to arrive at a monetary value for the usage pattern 106 of community shared vehicles.

The final category, enhancement of neighborhood characteristics 108 can be determined from factors such as the amount of time spent in a community shared vehicle and the increase in neighborhood interactions due to the use of the community shared vehicle program. The amount of time spent in the community shared vehicles can be translated to a monetary value per unit of time by multiplying the time spent by an average time value of an individual. The increase in neighborhood interactions can depend on the percentage of participating homeowners using the program in a community, the frequency of use of the community vehicles, and any shared use of the community vehicles by more than one participating homeowner. The increase in neighborhood interactions can also include the number of interactions on social media referencing the community shared vehicle program, the use of the program, or events or destinations reached by using the program. These factors can be assigned a weighting factor based on a predetermined average or benchmark.

The data used to determine each of the difference 102 in residual value, the transportation cost savings 104, the value of the usage patterns 106, and the value of enhancement of neighborhood characteristics 108 is collected throughout the program as described above.

It is contemplated that when sufficient data is collected to verify the amenity value of the community shared vehicle programs, the amenity value will be included as a benchmark provided by NAHB, requiring weighting based on geography and number of homes in the community, for example. For each update period, during which data is being collected, an updated amenity value is determined. This updated amenity value is used in combination with a home appraisal of homes in the service community, as further described below, to determine if there is an increase or decrease in the available profit pool.

A method of determining the updated amenity value in step S26 of FIG. 1 is shown in FIG. 3. As shown in FIG. 1, the updated amenity value in step S26 is reiterated periodically at update periods during the term, so that the updated amenity value becomes increasingly more accurate as the term of the financial product lapses. At the end of the first update period, the amenity value is updated using the data collected during that first update period. At the end of the second update period, the amenity value is updated using the data collected since the first update period through the second update period. At the end of the nth update period, the amenity value is updated using the data collected since the nth−1 update period.

Referring to FIG. 3, in step S100, the vehicle contribution value 102 of the EVs, the difference in residual value at the update period and the residual value at the previous update period (or start of program) is determined. In step S102, the transportation cost savings 104 are determined based on utility and/or fuel savings realized by the users of the program and the opportunity cost savings realized by the users of the program during the update period. In step S104, the value of the usage pattern 106 of the shared vehicles is determined based on one or more of the miles driven per day, the number of trips per day, and the destinations. In step S106, the value of enhancement to the neighborhood characteristics 108 is calculated based on the time spent in the shared vehicles and the increase in community interactions. In step S108, the updated amenity value is determined from each of the factors 102, 104, 106, 108. Each of these factors 102, 104, 106, 108 is determined as a monetary value per time, time being the duration of the update period. The total amenity value is the total of these factors, and the total amenity value is divided by the number of participating homes in the serviced community to arrive at an amenity value per home. Alternatively, each factor 102, 104, 106, 108 can be determined on a per home basis, so that totaling the factors provides an amenity value per participating home.

At each update period, in addition to updating the amenity value of the CSV program, the home appraisal of each home in the serviced community is also determined. Home values in all communities change over time due to many factors, including location, available school systems, and other amenities available in the communities. The methods herein determine value that is added to the homes in the serviced community over and above an expected increase in home value that would have otherwise been realized.

Referring back to FIG. 1, in step S28, the determination of the home appraisal for each home in the community that is serviced by the CSV program is made. Determining the home appraisal of a particular home can be done using an established process such as that used by realtors for pricing homes or by tax assessors for property tax assessments. The home appraisal can be obtained from the tax assessment records or realtor records, or a process can be developed to determine the home appraisal specifically for the financial product if desired. Any method of determining the home appraisal of homes known to those skilled in the art can be used. The home appraisal of a home considers its location, age of construction, size, sales history and other considerations against those in an area in which the community is located, such as a city or portion thereof. A certain radius (e.g., 5-20 miles) may be used to limit the homes included in the comparative market analysis, the radius varying depending on the whether the community is an urban or rural community, for example.

It is contemplated that as the CSV system operates and its amenity value is realized by those in the serviced community, demand for homes in the serviced community will increase, increasing the value of those homes. As the amount paid for these homes increases due to the increase in demand, the home appraisal will increase.

In step S30, the updated amenity value per home is combined with the home appraisal for each participating home in the serviced community to arrive at a total home value per participating home in the serviced community. This total home value is compared to the respective home appraisal of the home in the serviced community at the previous update period, which will be the start-up of the program if at the first update period. A percent increase in home value during the update period will be determined from this comparison.

In step S32, the percent change in home value is compared to a change in home values as reported by a preselected housing price index. As an example of a housing price index, which is tied to the price of a home, the S&P/Case-Schiller housing price index for the region can be used. If the change in the home value is positive, meaning the home value has increased over the update period, and if the change is also better than the change in the housing price index over the same period, the method moves to step S34. As a non-limiting example, if the increase in home value is 0.5% and the change in the price index is −0.6%, the process moves to step S34 to determine an updated profit component based on an increase in home value of 1.1%. If the change in the home value is not positive, or if the change in home value is positive but less than the change in the price index, and the method proceeds back to step S18, where the periodic payment amount is determined. The periodic payment amount may not be adjusted because the change in home value is negative or is not greater than the home value index. However, the periodic payment can be adjusted if desired or required by the financial party, and may be adjusted depending on the updated program costs determined in step S22.

Although the percent change in home value for each participating home may not be equal for each participating home, it is contemplated that the percent change for each participating home will be similar and be generally higher or lower with respect to the preselected housing price index. The percent change in home value for each participating home can be averaged across the participating homes before comparing to the preselected housing price index.

In step S34, an updated profit component is determined based on the increase in home value over the home value index, as determined in step S32. This updated profit component will be considered in determining the periodic payments from each participating homeowner's line of credit in step S18. It is noted that a profit component is figured in to the periodic payment at the beginning of the program, so this profit component can be increased based on the increase in the home value. Any percentage of the increase in home value may be used to determine the change in the profit component. Thus, the profit to the financing party only increases if the homeowner is realizing a financial benefit from the community shared vehicle program. If there is no profit component determined in steps S26 through S34, the periodic fee can be unchanged from the previous period so that the financing party recoups its cost of financing the community shared vehicle program with its originally determined profit margins.

At the end of the term, the EVs, charging station and installation are paid in full. It is contemplated that both the financing party and the CSV program provider made a profit over the term based on the increase in home value resulting from the CSV program. The homeowner realized in increase in the value of his or her home. It is contemplated that if the homeowner were to sell his or her home at the end of the term, the homeowner would realize this increase in home value at the time of the sale, with the increase exceeding the amounts paid for participating in the CSV program over the term.

FIG. 4 illustrates a system for creating and updating the financial product by calculating the periodic payments. FIG. 4 is also illustrative descriptive of the income and pay-out to and from the financial product. To establish the financial product using the financial computing system 200, the program costs 202 are determined using actual figures when available and estimating other values for the term of the financial product. The cost of the financial fees 204 are ascertained, the fees including one or more of the cost of the derivative product, interest rate of the line of credit, home appraisal fees and the default swap fee. If applicable, the periodic out-of-pocket fees 206 paid by the participating homeowners will be determined for the term. In this example, these fees 206 will remain constant throughout the term. It is contemplated, though, that if the profit component were to exceed a certain threshold, any out-of-pocket fees would be reduced or eliminated in an effort to spread profitability to the homeowners in during the term, over and above any future profit to be realized due to an increase in home value.

The change in home value 208, used to initially determine the profit component, is only equal to the estimated amenity value because at the start of the program, the increase for the home appraisal for the term of the financial product is estimated to be equal to the estimated increases in a specified home value index and hence the difference is zero. The change in home value 208 at the beginning of the program is determined by the estimated amenity value for the program over the term of the financial product. These amounts 202, 204, 206, 208 are combined and a payment amount is calculated per payment period over the term per participating homeowner. A margin 210, some percentage of the payment, may be added to account for the inaccuracies in determining the amenity value 208 and program costs 202. In this example, the margin will not change over the life of the term. However, it is contemplated that the margin could be adjusted if desired or required. For example, the margin could be eliminated if the profit component exceeds a certain threshold. The margin could be increased if the program costs increase over a certain threshold.

During the first update period, the CSV program operates and data is collected as described herein. During the update period, the periodic payment is made, with a portion 212 paying for the program costs, a portion 214 paying the financial product fees, and a portion 216 paid as profit to the CSV program provider and/or the financing party. At the end of the first update period, using the data collected, the program costs 202 are calculated for the update period. If the program cost per first update period has increased or decreased for the updated period when compared to the estimated program cost per term, the period payment can be adjusted to account for this increase or decrease. For example, if utility costs unexpectedly increase during the update period, the overall costs of the program would increase during the update period. The costs per unit time would increase when compared to the estimated program cost over the term.

At the end of the first update period, the change in total home value 208 is calculated for the update period. The updated amenity value is determined as described herein using the data collected for the update period. The home appraisal for the updated period is determined. These are combined to arrive at a total home value, and the increase in total home value is determined by comparing the total home value at the update period to the total home value when the program was started. If an increase in total home value is realized to be greater than the home pricing index, all or some portion of this increase over the home pricing index is used to update the profit component that is paid out by each participating homeowner on the periodic basis to the CSV program provider and/or financing party.

This process is repeated at the end of every update period. As a non-limiting example, if the term is four years and an update period is one year, the process will occur after the first year, after the second year, and after the third year.

This method and system for financing CSV programs can be used to illustrate to homeowners or potential homeowners how they would benefit when they are contemplating purchasing a home in a community that offers a program, implementing a program in an existing community, or joining a program in their community in which a program is already established. The system assists in teaching the homeowner how the program benefits them and the community, how the fees for such a benefit are determined, and how payment for the program is actually made from this increase in value. The homeowner can be provided with an amenity calculator that can be used by the homeowner, as an example of the amenity calculations actually done in the methods and systems, so that the homeowner can visually see how his or her use of the community shared vehicle program actually increase the amenity value of the program. Actually being privy to a calculation of the amenity value when the homeowner's usage of the program is accounted for will incentive additional use of the program, further increasing its amenity value.

With the financial product for providing CSV programs, the financing party can profit from the financing fees and the fee for the credit default swap, as well as any profit received due to the increase in home values. The CSV program provider profits as it is collecting sufficient funds to pay down its costs incurred in financing the community shared vehicle program, as well as any profit received due to the increase in home values. The participating homeowner benefits as he or she has access to a community shared vehicle program without having to pay any sign-up or other large fee, with any out-of-pocket fee charged being a small periodic fee. Most or all of the fees paid by the participating homeowner are tied to his or her increase in home value. The participating homeowner also benefits if the increase in his or her home value over the term of the financial product, combined with the savings realized from the use of the community shared vehicle program, is greater than the total fees paid for the community shared vehicle program.

The financial products of the participating homeowners can be pooled and transferred into a special purpose vehicle (SPV) or other type of financial vehicle. Subsequently, the SPV can be re-divided in several ways based on risk exposure, geographic exposure, or demographics and sold to investors as new securities of varying prices and maturity dates. This new security product can be structured using specific pools of homeowners. As non-limiting examples, the new security product can include: (1) a product consisting of homeowners of a specific geography; (2) a product based on homeowners with specific ranges of credit ratings; (3) a product based on specific home value ranges; (4) and a product based on specific homeowner demographics. A ratings agency would rate the various new securities. The issuer of the new security product, for example, the bank or the financing party, will issue the new security product and collect a fee for this new security product. These fees will be another source of revenue for the issuer, albeit with a lower risk profile than directly owning the CSV program financial product. This securitization process provides the financing party with immediate payment for the principle of the debt note as well as a profit (i.e., financing fees) for the risk undertaken in initially issuing the debt note for the community shared vehicle programs. Banks can also charge fees to investors who invest in the new security product. And finally, the investor has a new security product in which he can invest, diversifying his portfolio.

Implementations of computing devices used to carry out the methods and processes (and the algorithms, methods, instructions, etc., stored thereon and/or executed thereby as described herein) may be realized in systems including hardware, software, or any combination thereof. The hardware can include, for example, computers, IP cores, ASICs, PLAs, optical processors, PLCs, microcode, microcontrollers, servers, microprocessors, digital signal processors or any other suitable circuit. In the claims, the term “processor” should be understood as encompassing any of the foregoing hardware or other like components to be developed, either singly or in combination.

In one example, a computing device may be implemented using a general purpose computer or general purpose processor with a computer program that, when executed, carries out any of the respective methods, algorithms and/or instructions described herein. In addition or alternatively, for example, a special purpose computer/processor can be utilized which can contain other hardware for carrying out any of the methods, algorithms, or instructions described herein. Further, some or all of the teachings herein may take the form of a computer program product accessible from, for example, a tangible (i.e., non-transitory) computer-usable or computer-readable medium. A computer-usable or computer-readable medium is any device that can, for example, tangibly contain, store, communicate, or transport the program for use by or in connection with any processor. The medium may be an electronic, magnetic, optical, electromagnetic or semiconductor device, for example.

As described herein, the methods and systems include a series of steps. Unless otherwise indicated, the steps described may be processed in different orders, including in parallel. Moreover, steps other than those described may be included in certain implementations, or described steps may be omitted or combined, and not depart from the teachings herein. The use of the term “collecting” is not meant to be limiting and encompasses both actively collecting and receiving data.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A computer-aided method for providing a derivative financing product for a community shared vehicle program comprising:
establishing a line of credit for each participating home to pay for the community shared vehicle program, wherein the line of credit derives value from both tangible and intangible values of the community shared vehicle program, by:
estimating, with a computer, a total home value per participating home at a start of a financing term based on an estimated amenity value of the community shared vehicle program for the financing term and a number of participating homes;
estimating a total cost of the community shared vehicle program for the financing term;
determining a cost per participating home based on the total cost and the number of participating homes; and
determining a periodic payment per participating home based on periodic payment throughout the financing term to be paid from the line of credit to cover the total cost of the community shared vehicle program while providing a profit.

2. The method of claim 1, wherein estimating the total cost of the community shared vehicle program comprises reducing the total cost by an out-of-pocket payment from each participating homeowner.

3. The method of claim 1, wherein the total cost of the community shared vehicle program includes a cost of shared vehicles, a cost of a charging system, installation costs of the charging system, insurance for the shared vehicles, maintenance costs, utility costs, and program operation cost.

4. The method of claim 3, wherein the total cost of the community shared vehicle program further includes cost of financial product fees, which includes one or more of interest rate cost, default swap fee, home appraisal fee, and derivative product fee.

5. The method of claim 1, wherein the financing term includes a plurality of data collection periods, the method further comprising:
updating the total home value per participating home at an end of each data collection period using data collected during a respective data collection period;
updating the total cost of the community shared vehicle program for the respective data collection period using data collected during the respective data collection period;
determining an updated cost per participating home based on the updated total cost and the number of participating homes; and
determining an updated periodic payment per participating home to be paid through a subsequent data collection period from the line of credit to cover the updated total cost of the community shared vehicle program while providing an updated profit payment.

6. The method of claim 5, wherein the data collected during the data collection period comprises one or more of:
data collected from an on-board vehicle controller of each shared vehicle, the data including one or more of miles driven per day, miles driven per leg of trip, number of destinations per day, type of destination and operating time per day of vehicle;
manually inputted data;
data collected from a GPS unit;
data collected from databases including one or more of regional fuel costs and regional electrical power costs; and
data collected by monitoring social media for one or more of a number and type of reference to the community shared vehicle program.

7. The method of claim 5, wherein updating the total home value comprises:
determining an updated amenity value of the community shared vehicle program for each participating home in a serviced community at the end of the data collection period;
determining a home appraisal at the end of the data collection period for each participating homeowner; and
combining the home appraisal with the updated amenity value to determine an updated total home value for each participating homeowner at the end of the data collection period, and
wherein determining the updated period payment comprises:
determining a percent increase in home value by comparing the updated total home value to a total home value at a start of the data collection period;
determining a difference between the percent increase and a preselected house pricing index, wherein a gain over the preselected house pricing index provides the stream of income; and
adjusting the periodic payment based on the difference, wherein the updated periodic payment is increased if the difference is positive, the increase providing the updated profit payment.

8. The method of claim 7, wherein determining the updated amenity value comprises:
collecting, with a computer system, data of a plurality of factors of the community shared vehicle program over a data collection period;
calculating a contributing value of each of the plurality of factors based on the data collected; and
calculating the amenity value of the community shared vehicle program per participating home from the value of each of the plurality of factors and a number of participating homes, wherein the amenity value per participating home is further configured to finance at least a portion of the community shared vehicle program.

9. The method of claim 8, wherein the plurality of factors includes a vehicle contribution value, transportation cost savings, a usage pattern of the shared vehicles, and an enhancement of neighborhood characteristics.

10. The method of claim 1, further comprising:
pooling the derivative financing products from a large number of consumers to develop securitized financial products based on a specific pool of homeowners; and
issuing the securitized financial product in exchange for an interest in the securitized product.

11. The method of claim 10, wherein the interest is an equity interest.

12. The method of claim 10, wherein the specific pool of homeowners includes one or more of: a pool of homeowners of a specific geography; a pool of homeowners having a credit rating within a specific range; a pool of homeowners having a home value within a specific home value range; and a pool of homeowners of a specific demographic.

13. A system for providing a derivative financing product for a community shared vehicle program comprising:
a computer system configured to carry out the operations of establishing a line of credit for each participating home to pay for the community shared vehicle program, wherein the line of credit derives value from both tangible and intangible values of the community shared vehicle program, the line of credit established by:
estimating a total home value per participating home at a start of a financing term based on an estimated amenity value of the community shared vehicle program for the financing term and a number of participating homes;
estimating a total cost of the community shared vehicle program for the financing term;
determining a cost per participating home based on the total cost and the number of participating homes; and
determining a periodic payment per participating home based on periodic payment throughout the financing term to be paid from the line of credit to cover the total cost of the community shared vehicle program while providing a profit.

14. The system of claim 13, wherein, when estimating the total cost, the computer system is further operable to reduce the total cost by an out-of-pocket payment from each participating homeowner.

15. The system of claim 13, wherein the total cost of the community shared vehicle program is estimated from a cost of shared vehicles, a cost of a charging system, installation costs of the charging system, insurance for the shared vehicles, maintenance costs, utility costs, program operation cost, interest rate cost, default swap fee, home appraisal fee, and derivative product fee.

16. The system of claim 13, wherein the financing term includes a plurality of data collection periods, the computer system further operable to:
update the total home value per participating home at an end of each data collection period using data collected during a respective data collection period;
update the total cost of the community shared vehicle program for the respective data collection period using data collected during the respective data collection period;
determine an updated cost per participating home based on the updated total cost and the number of participating homes; and
determine an updated periodic payment per participating home to be paid through a subsequent data collection period from the line of credit to cover the updated total cost of the community shared vehicle program while providing an updated profit payment.

17. The system of claim 16, wherein the data collected during the data collection period comprises one or more of:
data collected from an on-board vehicle controller of each shared vehicle, the data including one or more of miles driven per day, miles driven per leg of trip, number of destinations per day, type of destination and operating time per day of vehicle;
manually inputted data;
data collected from a GPS unit;
data collected from databases including one or more of regional fuel costs and regional electrical power costs; and
data collected by monitoring social media for one or more of a number and type of reference to the community shared vehicle program.

18. The system of claim 16, wherein, when updating the total home value, the computer system is operable to:
determine an updated amenity value of the community shared vehicle program for each participating home in a serviced community at the end of the data collection period; and
combine the updated amenity value with a home appraisal at the end of the data collection period for each participating homeowner to determine an updated total home value for each participating homeowner at the end of the data collection period, and
wherein, when determining the updated period payment, the computer system is operable to:
determine a percent increase in home value by comparing the updated total home value to a total home value at a start of the data collection period;
determine a difference between the percent increase and a preselected house pricing index, wherein a gain over the preselected house pricing index provides the stream of income; and
adjust the periodic payment based on the difference, wherein the updated periodic payment is increased if the difference is positive, the increase providing the updated profit payment.

19. The system of claim 18, wherein, when determining the updated amenity value, the computer system is further operable to:
collect data of a plurality of factors of the community shared vehicle program over a data collection period;
calculate a contributing value of each of the plurality of factors based on the data collected; and
calculate the amenity value of the community shared vehicle program per participating home from the value of each of the plurality of factors and a number of participating homes, wherein the amenity value per participating home is further configured to finance at least a portion of the community shared vehicle program.

20. The system of claim 13, further comprising a device operable to pool the derivative financing products from a large number of consumers to develop securitized financial products based on a specific pool of homeowners; and
issue the securitized financial product in exchange for an interest in the securitized product.
